(19) United States
(12) Patent Application Publication
(10) Pub. No.: US 2005/0185653 A1
(43) Pub. Date: Aug. 25, 2005

(54) Communication apparatus

(76) Inventors: Hideaki Ono, Hagi (JP); Hideaki Takusagawa, Kawasaki (JP)

Correspondence Address: KATTEN MUCHIN ROSENMAN LLP, 575 MADISON AVENUE, NEW YORK, NY, 10022-2585, US

(21) Appl. No.: 10/978,800

(22) Filed: Nov. 1, 2004

(30) Foreign Application Priority Data
Feb. 25, 2004 (JP) 2004-050589

(51) Int. Cl. H04L 12/56

(52) U.S. Cl. 370/395.21; 370/328

(57) ABSTRACT

To provide a communication apparatus that is capable of selecting an appropriate network according to communication quality of a network and conditions required by an application using the network. When communication with a correspondent node is performed via plural networks, communication quality information is acquired for each of the plural networks, a storing unit storing conditions required by applications using the networks is referenced, the required conditions and the communication quality information of the respective networks are compared, a network satisfying the required conditions is selected, and communication is performed via the selected network.

### BACKGROUND OF THE INVENTION

The present invention relates to a communication apparatus for performing communication by selecting a network to be used from plural networks. More specifically, the present invention relates to a mobile communication network using a mobile IP technique for mobility management, which is a mobile communication system using a mobile node that is capable of making connection to plural access interfaces simultaneously.

In accordance with popularization of the Internet, communication using the Internet Protocol (IP) has been widely spread. In addition, since a mobile IP, which allows mobile communication using the IP, has been examined in IETF, mobile communication using the mobile IP is also within the realm of future possibility. The mobile IP is a technique for registering an address CoA (Care of Address) in a present moving destination of a mobile node MN in a home agent HA to thereby make it possible to continue communication even if the mobile node MN moves.

A communication method using the mobile IP will be explained using FIG. 13. First, it is assumed that the mobile node MN is making connection to a sub-network router AR1 in the figure. The address CoA of the mobile node MN at this point is CoA1. When the mobile node MN moves to the sub-network router AR1, the mobile node MN obtains CoA1 and registers it in a binding cache BC of the home agent HA using a location registration message binding update BU.

A correspondent node CN sends a packet addressed to a home address HoA of the mobile node MN. When the packet is transmitted to a network where the home agent HA is present on the basis of the home address HoA, the home agent HA intercepts the packet, encapsulates the packet using the address CoA1, which is obtained by referencing the cache BC of the home agent HA, and sends the packet. In other words, since an address of the encapsulated packet is CoA1 that is the present address of the mobile node MN, the packet is transmitted to the mobile node MN at the network router AR1.

When the mobile node MN receives the packet, the mobile node MN decapsulates the packet and extracts the original packet addressed to HoA to thereby interpret that the packet is sent to its own HoA. In this way, it becomes possible to receive a packet in a moving destination.

Next, in a case in which the mobile node MN has moved to a sub-network router AR2, immediately after the movement, the mobile node MN acquires an address CoA2 that is used in the network router AR2 of the moving destination. The mobile node MN registers the address CoA2 in the cache BC of the home agent HA using a location registration message (BU). Consequently, the address in the cache BC is replaced with CoA2.

The correspondent node CN sends a packet addressed to the home address HoA of the mobile node MN in the same manner as before. Therefore, in the same manner, the packet is transmitted to the network where the home agent HA is present, the home agent HA intercepts the packet, encapsulates the packet using an address, which is obtained with reference to the cache BC of the home agent HA, and sends the packet. At this point, since the address in the cache BC is replaced with CoA2, the home agent HA encapsulates the packet using the address CoA2 this time. In other words, since an address of the encapsulated packet is CoA2 that is the present address of the mobile node MN, the packet is transmitted to the mobile node MN at the network router AR2.

The mobile node MN decapsulates the packet and extracts the packet addressed to the mobile node MN. Since the packet after the decapsulation is a packet addressed to the same destination as the packet sent earlier, the mobile node MN is not required to perform processing for movement in an upper application even if the mobile node MN moves among networks.

In this way, when the mobile IP is used, even if the mobile node MN moves, communication with the correspondent node CN can be continued without change (without interrupting the upper application).

On the other hand, various access networks have been developed and put to practical use at present. For example, various access networks such as third-generation mobile communication network (hereinafter referred to as 3G), second generation mobile communication network (PDC in Japan, GSM in Europe, hereinafter referred to as 2G), PHS, wireless LAN, specific power saving radio (e.g., Bluetooth (registered trademark)), LAN used in companies and the like (e.g., Ethernet (registered trademark)), wide-area Ether, ADSL, and ISDN are usable.

Under such an environment, a user is also capable of selecting and using an optimal access network all the time. (See Non-Patent document 2)

In addition, using plural access lines simultaneously is also possible. More specifically, with the method, advertisement information is always received only through a wireless LAN line with low communication charge and, simultaneously, data is sent and received using a PHS line with which data quality is secured.

Moreover, as another usage example, a company provides an employee with a 3G card for business use and the employee also has a PHS card personally, the employee connects both the 3G card provided by the company and the PHS card owned personally to one PC and selects a card to be used according to a purpose of use. More specifically, the employee uses the PHS card owned personally in accessing web sites privately at home and uses only the 3G card in always receiving emails for work and checking the emails. To realize such usage, a technique is necessary, which allows a user to use an access line properly for each application without becoming conscious of selecting various access lines. As a technique for realizing this, the inventors of the present invention and others filed International Patent Application JP03/06252. This is a technique for allowing the home agent HA to select a packet transmission path for each application, for example, by selecting the address CoA according to an application attribute.

In addition, as a prior art related to the present invention, for example, there are techniques disclosed in the following documents.
[Patent document 1] JP 11-201783 A
[Patent document 2] JP 2002-252620 A
[Non-Patent document 1] Koji Sato and five others, “A Framework for the Coordination of Applications and Networks”, Japan Society of Software Science & Technology, Software System Workshop, 2002. [Retrieved Dec. 2, 2003], Internet <URL: http://spa.jssst.or.jp/2001/Sato.pdf>
[Non-Patent document 2] “First in Japan! Middleware for automatically switching to an optimal network”, Fujitsu Limited., Jan. 27, 2003[Retrieved Dec. 2, 2003] Internet <URL: http://pr.fujitsu.com/jp/news/2003/01/27.html>

### DISCLOSURE OF THE INVENTION

### SUMMARY OF THE INVENTION

However, only with the technique, there are problems as described below. In short, even if a desirable access network is simply selected out of plural access networks in accordance with attributes of an application, it may be difficult to secure expected quality depending upon a state of the selected network.

For example, it is assumed that, when the node MN has moved to an area where it is possible to use a wireless LAN, since the wireless LAN has the largest band at that point, the node MN makes connection to a network through the wireless LAN. However, there is a possibility that a large number of users are using the wireless LAN in the area, and no available free band is left. In such a case, it is needless to switch to the wireless LAN, and it would rather be better not to switch to the wireless LAN.

In another example, in the case of using an application such as voice call, with which communication cannot be performed properly unless strict conditions for an end-end delay (end-end delay of 150 ms or less, etc.) are satisfied, when an access network is switched to an access network available in a moving destination, congestion may occur midway in the path, and quality of call may be deteriorated to the contrary by switching the access network.

In this way, in the conventional technique, it is not considered that selection of a line with full understanding of a state of a network is performed, and it is not always possible to select a network in a state in which quality required by an application can be secured.

Therefore, it is an object of the present invention to provide a technique that makes it possible to select and use a network with which quality required by an application can be secured.

In order to solve the problems, the present invention adopts means described below. The present invention provides a communication apparatus capable of communicating with a correspondent node via plural networks, including:
a quality acquiring unit that acquires communication quality information for each of the plural networks;
a storing unit that stores conditions required by an application using the networks;
a selecting unit that compares the required conditions in the storing unit and the communication quality information of the respective networks and selects a network satisfying the required conditions; and
a communication control unit that performs communication via the network selected by the selecting unit.

When the communication control unit sends a packet in accordance with the application, the communication control unit may send the packet through the network selected by the selecting unit.

The communication control unit may notify the correspondent node of information on the network selected by the selecting unit and receive a packet from the correspondent node via the selected network.

When communication is performed with the correspondent node via a relay node that relays a packet from the correspondent node,
the quality acquiring unit may acquire communication quality information from the relay node.

When communication is performed with the correspondent node via a relay node,
the quality acquiring unit collects information on communication quality of the network, and
the communication control unit notifies the relay node of information on the network selected by the selecting unit and receives a packet from the relay node via the selected network.

When a network satisfying the required conditions is not present, the selecting unit may select a network in accordance with conditions for selection that are applied in a case in which a network satisfying the required conditions is not present.

When plural applications using the network are present simultaneously, the selecting unit may select networks used by the respective applications in accordance with conditions for selection among the applications.

When the network is switched,
the selecting unit may select and execute a method of switching the network according to communication quality information of the network before and after the switching.

When the network is switched, and a transfer differential delay before and after the switching is larger than a threshold value,
at least one of the communication control unit and the relay node may buffer a packet for execution in handover processing for the switching.

The quality acquiring unit may inquire of a specific node, which collects information on a state in a network, about a state of a pertinent network and acquire communication quality information for execution.

An access point of the network may notify communication quality information of the access point itself, and the quality acquiring unit may acquire the communication quality information for execution.

An access point of the network may notify other access points of communication quality information of itself, and an access point having received the communication quality information may notify the notified communication quality information of other access points in addition to a quality state of the access point itself for execution.

The quality acquiring unit may acquire communication quality information only in a case in which an application requiring acquisition of communication quality is used and may acquire no communication quality information in a case in which an application not requiring acquisition of communication quality is used.

In addition, the present invention provides a communication system, including: a relay node that relays a packet from a correspondent node to a communication apparatus moving among plural networks; and a communication apparatus that performs communication with the correspondent node via the plural networks, in which:
the relay node includes:
a quality detecting unit that detects communication quality information of the plural networks;
a quality notifying unit that notifies the communication apparatus of the communication quality information;
a selection information receiving unit that receives information on a selected network from the communication apparatus; and
a transferring unit that transfers a packet addressed to a home address of the communication apparatus from the correspondent node to the communication apparatus via the selected network; and
the communication apparatus includes:
a quality acquiring unit that acquires communication quality information from the relay node;
a storing unit that stores conditions required by an application using the network;
a selecting unit that compares the required conditions in the storing unit and communication quality information of the respective networks and selects a network satisfying the required conditions; and
a communication control unit that notifies the relay node of information on the network selected by the selecting unit and receives a packet sent from the relay node via the selected network.

In addition, the present invention provides a communication method executed in a communication apparatus that is capable of communicating with a correspondent node via plural networks, including:
a step of acquiring communication quality information for each of the plural networks;
a step of referencing a storing unit that stores conditions required by an application using the network, comparing the required conditions and the communication quality information of the respective networks, and selecting a network satisfying the required conditions; and
a step of performing communication via the network selected by the selecting unit.

In addition, in the step of performing communication, in a case in which a packet is sent in accordance with the application, the packet may be sent through the selected network.

In the step of performing communication, information on the selected network may be notified to a correspondent node and a packet may be received from the correspondent node via the selected network.

When communication is performed with the correspondent node via a relay node,
communication quality information may be acquired from the relay node.

When communication is performed with the correspondent node via a relay node,
in the step of acquiring communication quality information, information on communication quality of the network may be collected, and
information on the selected network may be notified to the relay node on the basis of the communication quality information, and a packet may be received from the relay node via the selected network.

In the step of selecting a network, in a case in which a network satisfying the required conditions is not present, a network may be selected in accordance with conditions for selection that are applied in a case in which a network satisfying the required conditions is not present.

In the step of selecting a network, in a case in which plural applications using the network are present simultaneously, networks used by the respective applications may be selected in accordance with conditions for selection among the applications.

When the network is switched,
in the step of selecting a network, a method of switching the network may be selected for execution according to communication quality information of the network before and after the switching.

When the network is switched, and a transfer differential delay before and after the switching is larger than a threshold value, packet in handover processing for the switching may be buffered.

In the step of acquiring communication quality information, a specific node, which collects information on a state in a network, may be inquired about a state of a pertinent network, and communication quality information may be acquired from the node.

When an access point of the network notifies communication quality information of the access point itself, in the step of acquiring communication quality information, the communication quality information from the access point may be acquired.

An access point of the network may notify other access points of communication quality information of itself, and an access point having received the communication quality information may notify the notified communication quality information of other access points in addition to a quality state of the access point itself.

In the step of acquiring communication quality information, communication quality information may be acquired only in a case in which an application requiring acquisition of communication quality is used, and communication quality information may not be acquired in a case in which an application not requiring acquisition of communication quality is used.

A communication method executed in a communication system including: a relay node that relays a packet from a correspondent node to a communication apparatus moving among plural networks; and a communication apparatus that performs communication with the correspondent node via the plural networks, including:
causing the relay node to perform:
a step of detecting communication quality information of the plural networks;
a step of notifying the communication apparatus of the communication quality information;
a step of receiving information on a selected network from the communication apparatus; and
a step of transferring a packet addressed to the communication apparatus from the correspondent node to the communication apparatus via the selected network; and
causing the communication apparatus to perform:
a step of acquiring communication quality information from the relay node;
a step of referencing a storing unit that stores conditions required by an application using the network, comparing the required conditions and communication quality information of the respective networks, and selecting a network satisfying the required conditions; and
a communication control step of notifying information on the selected network to the relay node and receiving a packet sent from the relay node via the selected network.

In addition, the present invention may be a communication program that causes a communication apparatus (including a computer and an information processing apparatus) to execute the steps.

In addition, the present invention may be a recording medium that records the communication program such that the communication apparatus is capable of reading the communication program. Then, by causing the communication apparatus to read and execute the program in the recording medium, a function of the program can be provided.

Here, the term recording media readable by a communication apparatus means recording media that can store information such as data and programs according to an electric, magnetic, optical, mechanical, or chemical action and from which the apparatus can read the information. Among such recording media, those removable from the apparatus are, for example, a flexible disk, a magneto-optical disk, a CD-ROM, a CD-R/W, a DVD, a DAT, an 8 mm tape, and a memory card.

In addition, as recording media fixed in the apparatus, there are a hard disk, a ROM (read only memory), and the like.

In this way, in the present invention, the problems are solved by obtaining states of plural access networks and transfer paths (communication quality information) and selecting a network satisfying conditions required by an application with full understanding of the state. The state of networks (communication quality information) is, for example, information such as a transfer delay time, a free band, and an error rate.

As the transfer delay time, it is possible to measure and use a transfer delay among nodes or network apparatuses. As to the free band and the error rate, network cards of mobile nodes hold the information, and it is possible to obtain the information by using the network card.

A method with which a mobile node obtains information on a network state will be hereinafter explained.

Interfaces such as a wireless LAN card, a 3G card, a PHS card, and an Ethernet card (an Ethernet interface is incorporated in almost all PCs at the present point) can be connected to the mobile node. The mobile node can obtain information on a network state from the respective interfaces. For example, with the 3G card, it is possible to make a reference about a state of connection to a 3G network (within or out of a communication zone) using an AT command or confirm an error state of a reception frame by using an OID command. In the case of the wireless LAN card, it is also possible to obtain radio wave quality such as a radio field intensity and an error rate using the OID command. Although it is difficult to obtain the delay time independently, it is possible to obtain a round-trip delay by executing ping command between the mobile node and a correspondent and between the mobile node and a home agent HA.

It is possible to check quality in the case of using the respective interfaces by using these pieces of information effectively.

Since a communication application has conditions required of a network (e.g., end-end delay of 150 ms or less) for each kind of communication quality, it is sufficient to compare the conditions with the quality of the respective networks obtained by the method mentioned above and select a network (or an interface) satisfying the required conditions.

In addition, depending upon a characteristic of an application, some applications require information on an end-end delay and other applications do not require the information. Since delay measurement involves load more or less between measured nodes, it is desirable to measure a delay only in a case in which an application requires the delay measurement. For example, it is desirable to perform the delay measurement only for VOIP and TV telephone, and make the delay measurement unnecessary in other applications.

A network selection operation, on which a result of such measurement is reflected, will be explained next using FIG. 1.

1. As load information of a network, obtain information on whether or not a packet transfer delay and congestion occur and a usable band for each packet transfer path that a node MN (equivalent to a communication apparatus) can use.

2. Judge which path (network) is optimal for use using the obtained information.

3. Designate a path such that a home agent HA uses a selected path. In the mobile IP, the designation of a path is realized by registering a care of address CoA, which corresponds to an HoA (a home address of the node MN) and a line card, in the home agent HA.

4. Perform the judgment for each application performing communication. Consequently, even in a case in which plural communication applications are used simultaneously, it becomes possible to select and use an optimal path, on which a network state is reflected, for each application.

Concerning the designation of a path for each application, there is a method of judging an application type using a port number, which is used by the application, with respect to one HoA, and a method of allocating an individual HoA to each application.

In both the methods, it is possible to combine the present invention with the methods.

In addition, extension as described below is also possible.

5. Concerning band calculation usable in the selected network, bands are allocated to applications in order from an application with a highest priority, and communication is stopped when a band required by an application cannot be satisfied.

6. When an application has a delay condition, a path not satisfying the delay condition is not selected.

7. In order to notify the mobile node MN of a load state of a radio network, information such as an average traffic amount and a free band collected by an apparatus on a radio base station side is notified to the mobile node MN, and the mobile node MN receives the information and uses the information for network selection.

8. The average traffic and free band information described in (7) is notified to the home agent HA, and the home agent HA selects a path to a transfer destination using the information.

9. A handover method is selected in accordance with states of a network before and after switching. For example, in a case in which there is a transfer differential delay in the network before and after switching, a handover method for preventing reversal of a packet order and packet loss due to the differential delay is selected and executed.

According to the present invention, appropriate network selection according to communication quality of a network and conditions required by an application using the network becomes possible.

### DESCRIPTION OF THE DRAWINGS

FIG. 1 is a schematic diagram of a communication system in accordance with the present invention.

FIG. 2 is a schematic diagram of a communication apparatus in accordance with the present invention.

FIG. 3 is a schematic diagram of a home agent.

FIG. 4 is an explanatory diagram of an example of delay measurement.

FIG. 5 is an explanatory diagram of a delay measurement sequence.

FIG. 6 is an explanatory diagram of a network selection operation.

FIG. 7 is an explanatory diagram of a handover operation.

FIG. 8 is an explanatory diagram of a packet reception operation.

FIG. 9 is an explanatory diagram of a packet transmission operation.

FIG. 10 is an explanatory diagram of acquisition of band information using a wireless access point.

FIG. 11 is a diagram showing an example of a delay table.

FIG. 12 is a diagram showing an example of a table of conditions required by applications.

FIG. 13 is an explanatory diagram of a conventional technique.

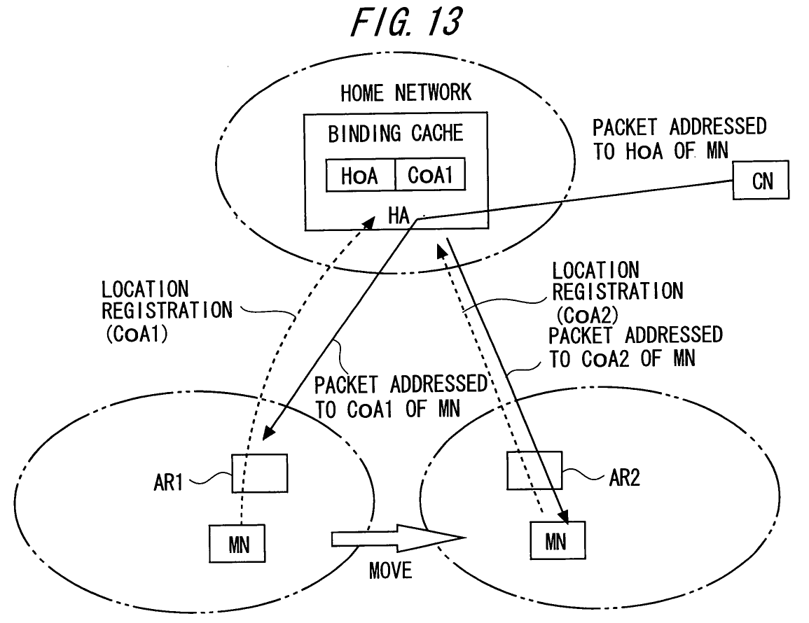

### DETAILED DESCRIPTION OF THE INVENTION

A best mode for carrying out the present invention will be hereinafter explained with reference to the drawings. Structures in the following embodiments are merely adopted as an example, and the present invention is not limited to the structures of the embodiments.

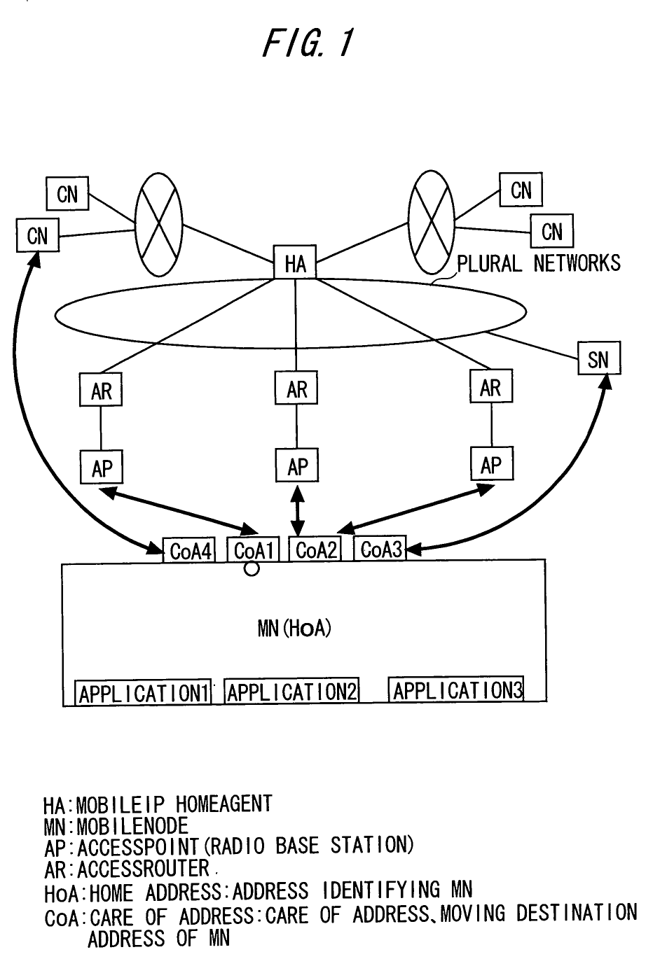

FIG. 1 is a schematic diagram of a communication system in accordance with the present invention. A communication system of the embodiment includes a communication apparatus (also referred to as a mobile node) MN that is capable of moving among plural networks and a home agent (relay node) HA that relays a packet from a correspondent node MN to the mobile node MN.

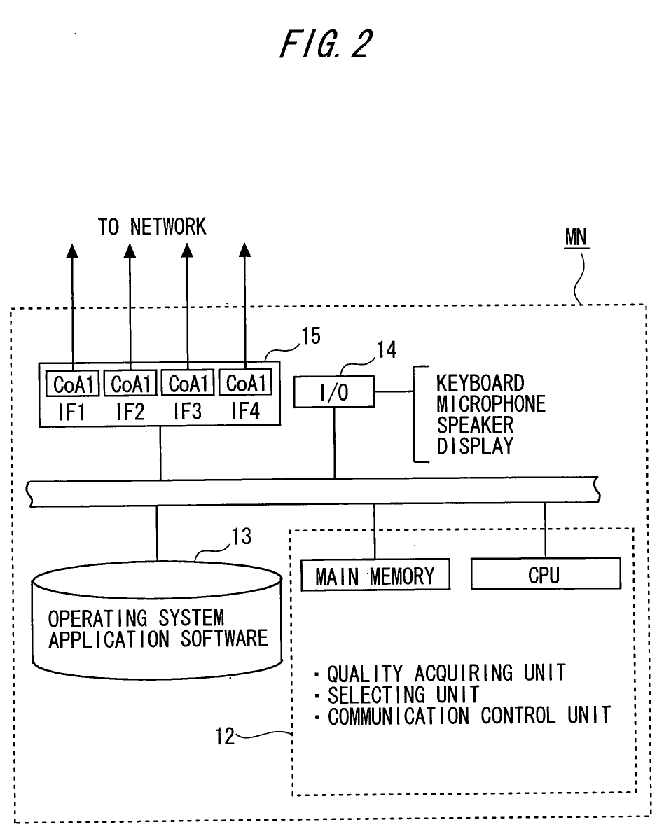

FIG. 2 is a schematic diagram of the mobile node MN. As shown in the figure, the mobile node MN is a general computer (information processing apparatus) including an arithmetic processing unit 12 composed of a CPU and a main memory, a storing unit (a RAM, a hard disk, etc.) 13, an input/output unit (I/O) 14, and a communication interface 15. For example, the mobile node MN may be any apparatus such as a PDA, a cellular phone, and a notebook personal computer as long as the apparatus is capable of performing communication via plural networks in accordance with an application program. In other words, the mobile node MN may be a communication apparatus, which does not usually move, as long as the apparatus performs communication by switching plural networks.

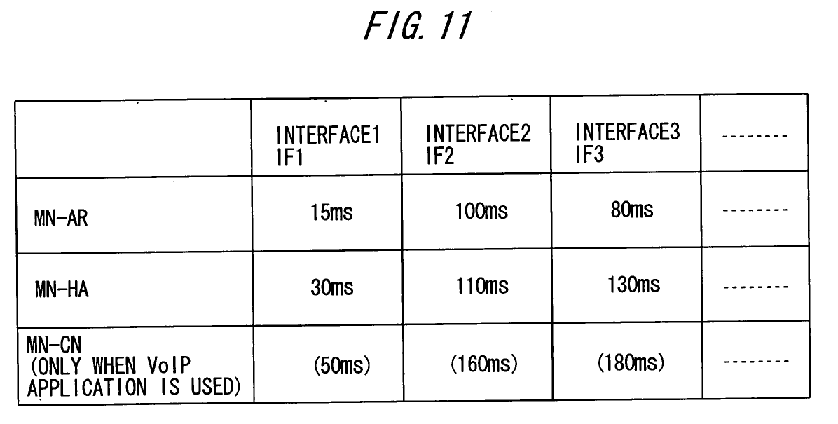

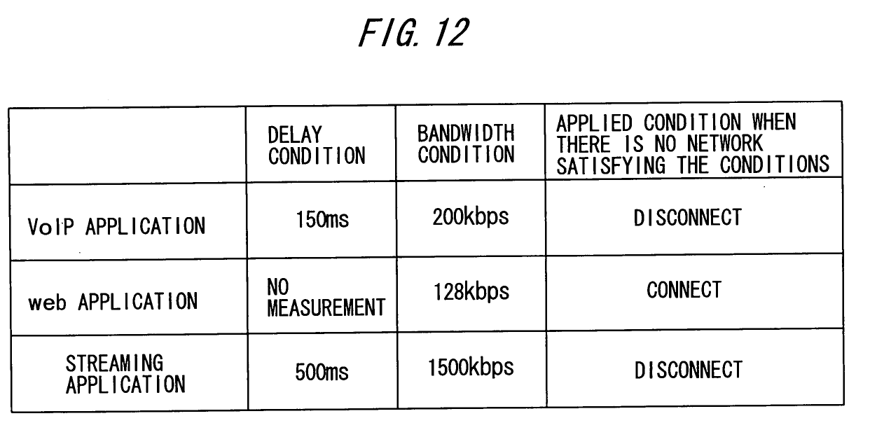

The storing unit 13 stores a communication program for performing communication using the plural networks, an application program (simply referred to also as application) for browse of web sites, IP telephone, electronic mails, and the like via the networks, and an operating system. In addition, the storing unit 13 stores a delay table shown in FIG. 11 and a table of conditions required by applications shown in FIG. 12.

The arithmetic processing unit 12 reads out and executes the programs stored in the storing unit 13 according to circumstances to thereby perform communication or the like with the correspondent node CN. In particular, in the embodiment, the arithmetic processing unit 12 realizes functions of a quality acquiring unit, a selecting unit, a communication control unit in accordance with a communication program.

The quality acquiring unit acquires communication quality information for each of the plural networks. The communication quality information is acquired by receiving communication quality information from the home agent HA and an access point or measuring a delay as described below.

The selecting unit compares the required conditions in the storing unit 13 and the communication quality information of the respective networks and selects a network satisfying the required conditions.

The communication control unit notifies the home agent of information on the network selected by the selecting unit and receives a packet sent from the home agent via the selected network.

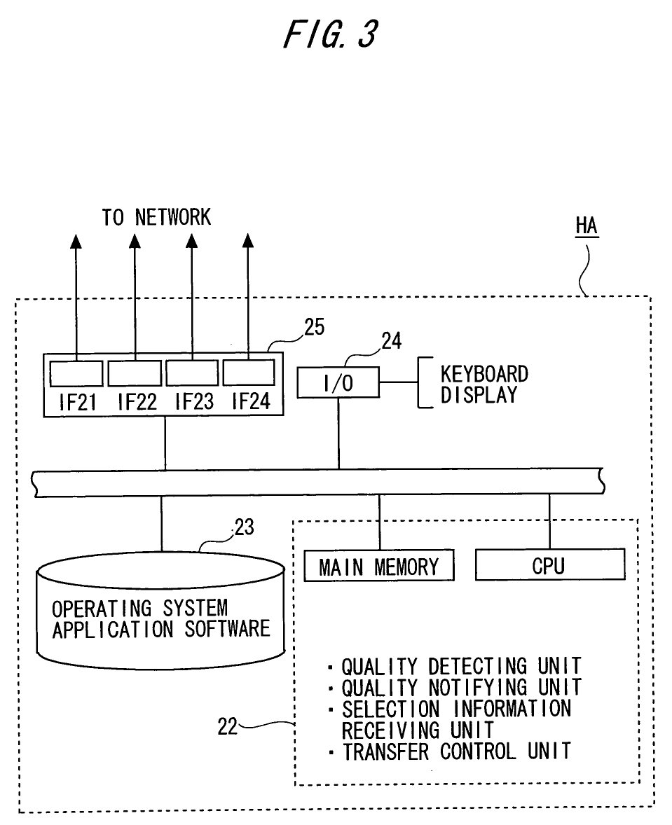

FIG. 3 is a schematic diagram of the home agent in accordance with the present invention. As shown in the figure, the home agent HA is a general computer (information processing apparatus) including an arithmetic processing unit 22 composed of a CPU and a main memory, a storing unit (a RAM, a hard disk, etc.) 23, an input/output unit (I/O) 24, and a communication interface 25.

The storing unit 23 stores a program for performing communication using the plural networks and other programs. In addition, the storing unit 23 also includes a binding cache BU in which a care of address or the like of each mobile node MN is registered.

The arithmetic processing unit 22 reads out and executes the programs stored in the storing unit 23 according to circumstances to thereby relay a packet from the correspondent node CN to the mobile node MN. In particular, in the embodiment, the arithmetic processing unit 12 realizes functions of a quality detecting unit, a quality notifying unit, a selection information receiving unit, and a transfer control unit (equivalent to a transferring unit) in accordance with the programs.

The quality detecting unit detects communication quality information of the plural networks.

The quality notifying unit notifies the communication apparatus of the communication quality information.

The selection information receiving unit receives information on the selected network from the communication apparatus.

The transfer control unit transfers a packet addressed to a home address of the communication apparatus from the correspondent node to the communication apparatus via the selected network.

Note that, in the embodiment, the example in which general computers are used as the communication apparatus and the home agent is described. However, the present invention is not limited to this, and a dedicated electronic apparatus constituted by a circuit realizing the functions of the respective units may be adopted.

A procedure of communication according to those structures will be hereinafter explained.

### EXAMPLE OF ACQUISITION OF COMMUNICATION QUALITY INFORMATION

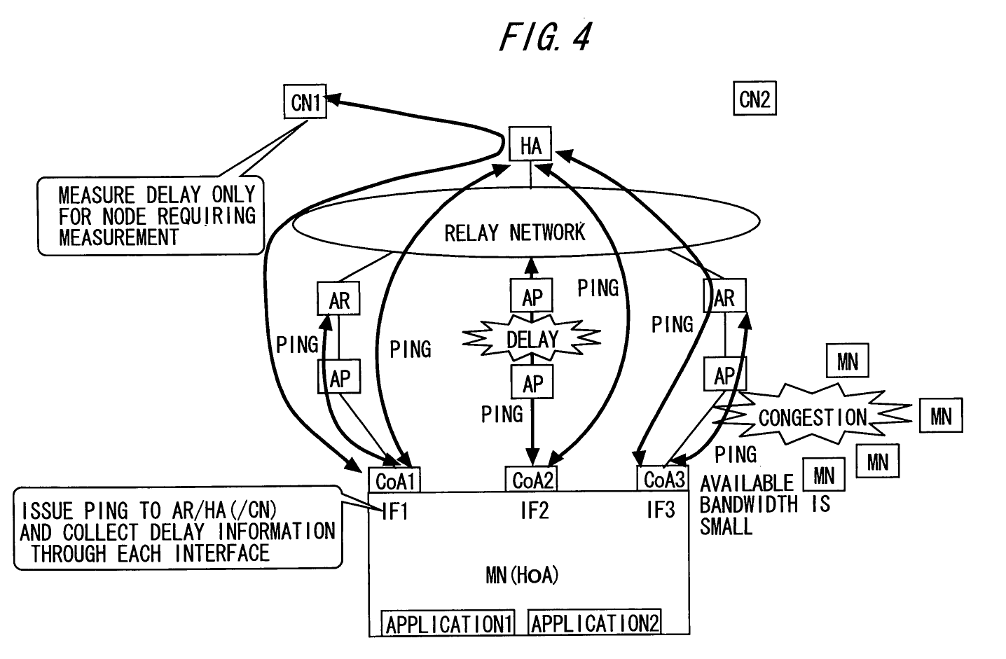

FIG. 4 shows an example of measurement of a delay as communication quality information. The quality acquiring unit of the mobile node MN is capable of issuing ping command to routers AR and the home agent HA from a communication interface 15 to perform delay measurement. In this case, in order to perform measurement for each of interface cards IF1 to IF3 of the communication interface 15, the mobile node MN sends ping command (echo request messages) through the respective interface cards. Concerning a destination of ping command, address information of the routers AR is included in a router advertisement message that the routers AR send periodically. In addition, since an MIP node usually registers a location in the home agent HA, an address of the home agent HA only has to be sent to the same destination as a location registration message thereof.

A value of the measured delay is stored in the delay table as shown in FIG. 11.

### EXAMPLE IN WHICH ONLY A SPECIFIC APPLICATION ACQUIRES COMMUNICATION QUALITY INFORMATION

On the other hand, the acquisition of communication quality information such as delay measurement from the correspondent node CN should be carried out only in a case in which a specific application is used.

This is because, for example, in the case of accessing a web server, a link destination of a web page is often linked to another server actually, and it is highly likely that communication with the server ends only by performing file transfer once. Therefore, an increase in load in a server and a network is caused when delay measurement is performed with separate servers every time communication is performed. In addition, web access itself is not so strict about a transfer delay. Therefore, it is advisable to perform the delay measurement only when an application such as VoIP, in which an end-end delay significantly affects communication quality, is used.

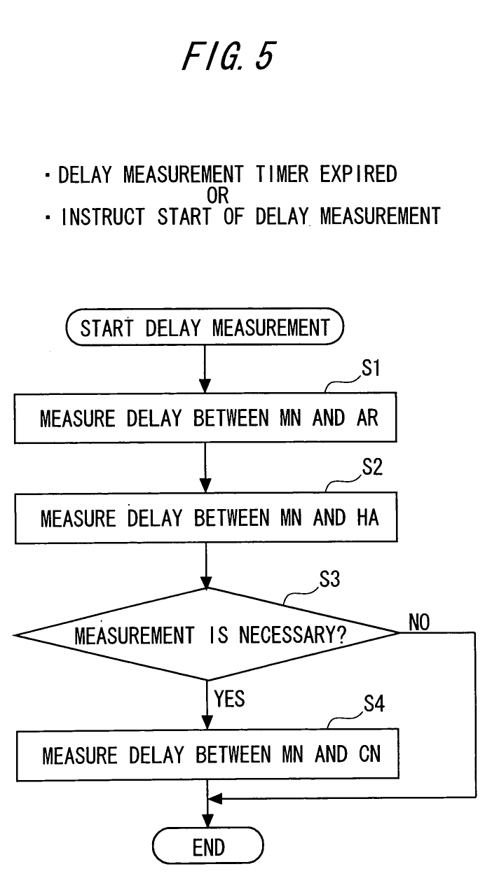

FIG. 5 shows an example of a delay measurement sequence. First, delay measurement between the mobile node MN and the routers AR and between the mobile node MN and the home agent HA (steps S1 to S2) to judge whether measurement is necessary with reference to the delay measurement table. For example, in the case of “no measurement” as in a Web application of FIG. 12, measurement is not performed, and in a case in which a threshold value of delay time is inputted as a delay condition as in the other applications, measurement between the mobile node MN and the correspondent node CN is performed (S4).

The delay measurement is executed periodically or started at a point when a measurement start instruction is received, for example, when communication is started anew or when a usable network is added. Delay measurement is performed between the mobile node MN and the routers AR and between the mobile node MN and the home agent HA, and if the mobile node MN is in VOIP communication, delay measurement between the mobile node MN and the correspondent node CN is also performed.

### EXAMPLE OF ACQUISITION OF BAND INFORMATION

Concerning acquisition of band information, in the case of a public line of a band guarantee type, which is one of 3G services, for example, a band of 64 kbps is guaranteed at a point when the public line is made connectable. Therefore, it may be considered that a band of 64 kbps is secured at a point when the public line is connected. On the other hand, for example, in a wireless LAN that is not a band guarantee type, plural users share a band in a wireless section. Therefore, when the users increase, an AP of the wireless LAN can be seen but no room is left in a free band, and sufficient quality cannot be secured in some cases. Even in such a case, the access point AP collects information on an available free band and notifies the mobile node MN of the information, whereby the mobile node MN can obtain specific band information.

<Network State Management Node>

A network state may be centrally managed by a specific node SN (FIG. 1). In such a case, it is also possible to inquire the node SN about a network state and receive (acquire) communication quality information from the node.

### EXAMPLE OF SELECTION OF AN OPTIMAL NETWORK

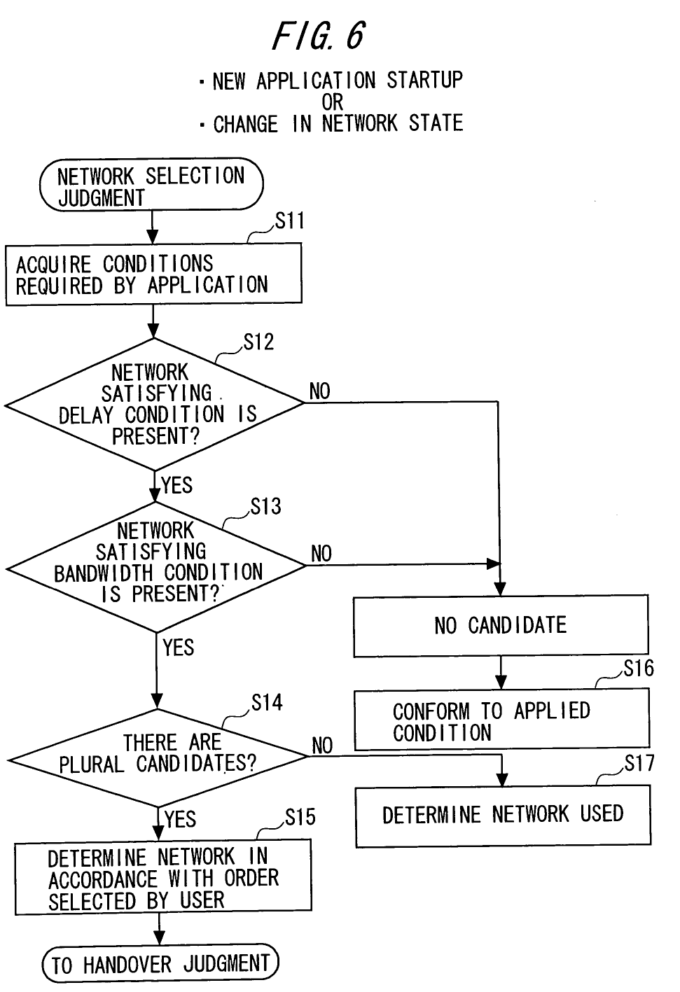

An operation example, in which the network state whose information is collected in this way is used to select an optimal network, is shown in FIG. 6. When an application is started anew or with a change in a network state as an opportunity, network selection is started. The collected information on network state and the required conditions of the respective applications (see FIG. 12) are compared to select a network satisfying the conditions. FIG. 6 shows an example in which a delay and a band are used as the conditions. In the case in which there is no network satisfying the conditions, the network is disconnected. If there are plural networks satisfying the conditions, the networks are narrowed down to one in accordance with an order of selection (e.g., prioritizing a low price, etc.) designated by a user to determine a network to be used by the application.

### EXAMPLE IN WHICH A SELECTION OPERATION IS PERFORMED IN AN ORDER OF PRIORITIES AMONG PLURAL APPLICATIONS

In the case in which plural applications are used simultaneously, priorities are given to the applications and stored in the storing unit 13 in advance. As shown in FIG. 6, conditions required by the applications are acquired (S11), it is judged whether there are networks satisfying a delay condition and a band condition (S12 to S13), if there is one candidate, the candidate is determined as a network to be used (S14, S17), and if there are plural candidates, a network to be used is determined in accordance with the priorities. In other words, bands are allocated (S14 to S15). On the other hand, if there is no candidate, processing for disconnection or connection is performed in accordance with conditions applied in a case in which no network is present with reference to the table of conditions required by applications (S16). In addition, in this case, it is also possible to execute the applications in order from one with the highest priority. In this case, in particular, concerning the band condition, since bands are used by the applications with higher priorities in order, there would be insufficient bands for the applications with lower priorities as the case may be.

### EXAMPLE OF AN OPERATION USING AN OPTIMAL SWITCHING METHOD AT THE TIME OF HANDOVER

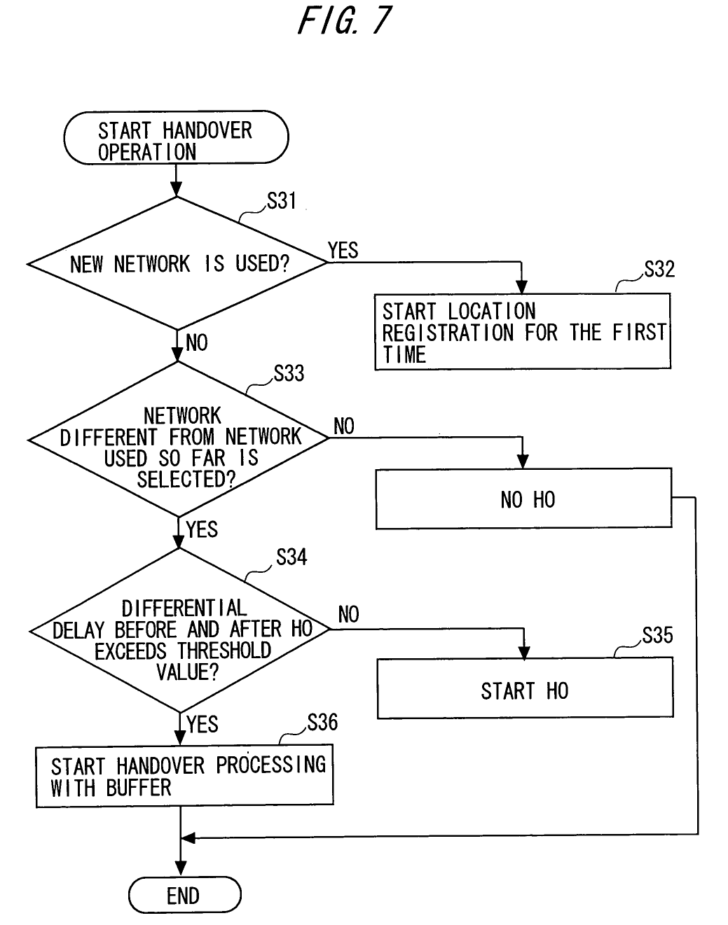

FIG. 7 is a diagram showing a handover operation in the case in which a selected network is different from a network where the mobile node MN has been connected or the case of using network for the first time in a stage of staring communication.

In the case of using new network newly, a location of the mobile node MN is registered in the home agent HA for the first time (S31 to S32). In the other cases in which the mobile node MN has been connected to a certain network, and a network different from the network is selected according to the flowchart of FIG. 6, handover processing is performed as processing for reconnection (S33 to S36).

In addition, in the case in which a transfer differential delay before and after HO is large, a packet loss countermeasure such as buffering of the home agent HA is applied to a packet in handover (S36), and if the transfer differential delay does not exceed a threshold value, handover is performed without buffering (S35).

### EXAMPLE OF A PACKET RECEPTION OPERATION

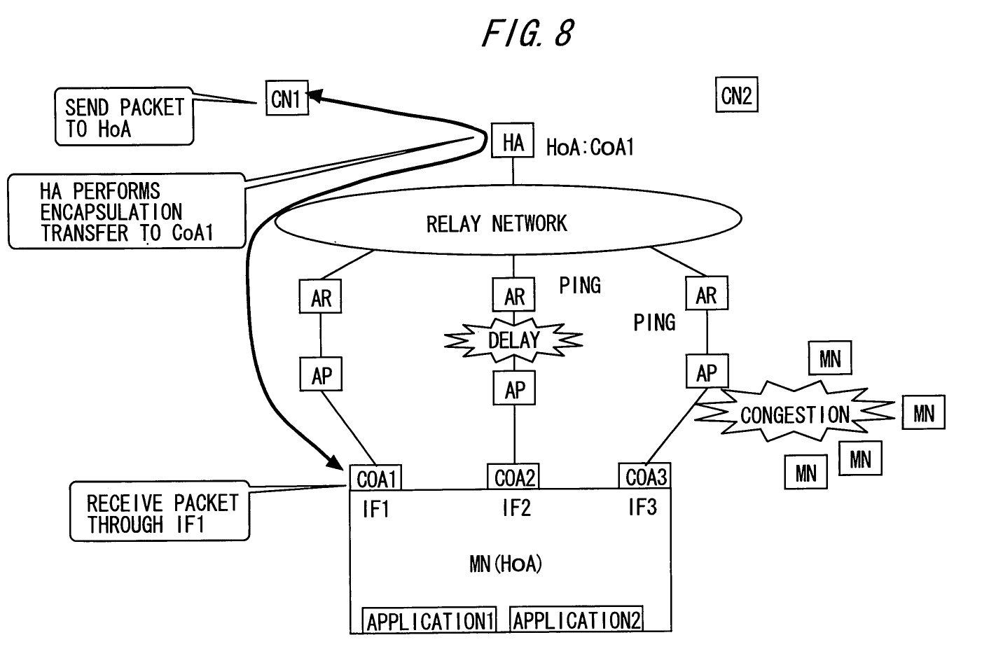

FIG. 8 shows an example of a packet reception operation. Viewed from the mobile node MN, a delay is large in a path in the center, and congestion occurs in a path on the right. CoA1 is registered with respect to HoA in the home agent HA such that a packet is sent using a path on the left avoiding the delay and the congestion.

When a correspondent node CN1 sends a packet to the mobile node MN (addressed to HoA), since the home agent HA performs capsule transfer to an address CoA1, the packet is transmitted through the path on the left.

### EXAMPLE OF A PACKET TRANSMISSION OPERATION

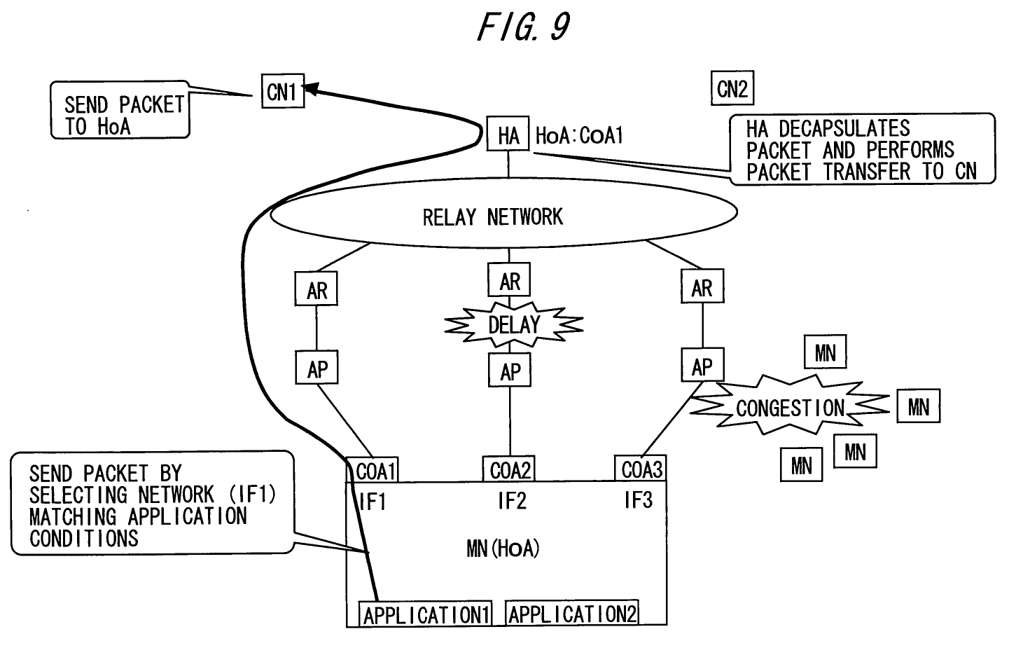

FIG. 9 shows an example of a packet transmission operation. To determine from which interface a packet is to be sent, the mobile node MN compares a network state (communication quality information), that is, a state of delay and congestion, and conditions required by an application, selects a path (network) satisfying the conditions, for example, selects a path on the left in FIG. 9, in which the conditions and a network state match, as an optimal path, and sends the packet in an encapsulated form to the home agent HA through the path.

### EXAMPLE OF ACQUISITION OF BAND INFORMATION USING A WIRELESS ACCESS POINT

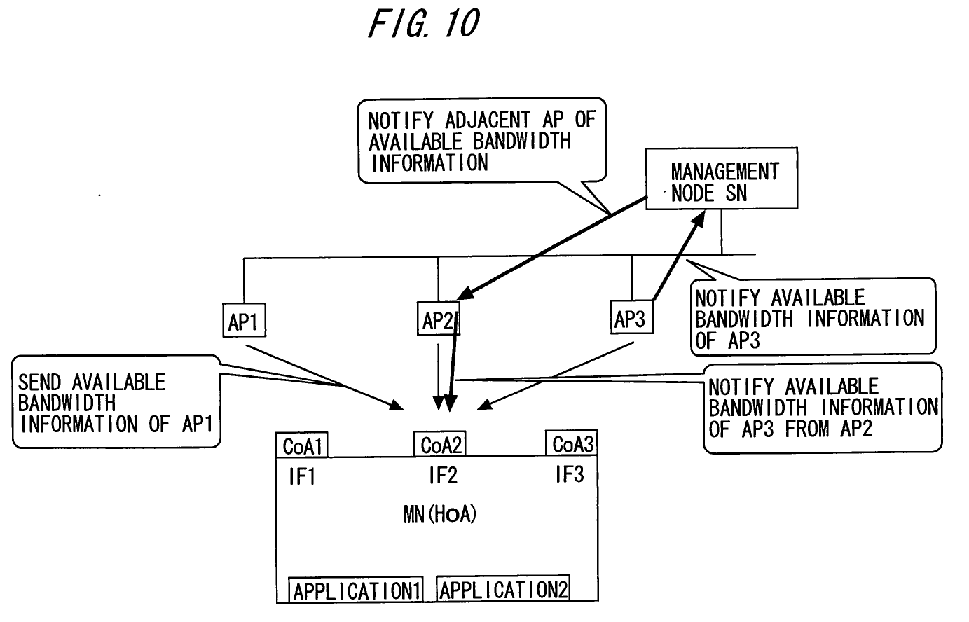

The above example is described on the premise that the mobile node MN can obtain band information. However, there is also a network, through which it is difficult to obtain free band information as it is, such as an ordinary wireless LAN. In such a case, a free band is notified to the mobile node MN by a system as shown in FIG. 10.

A wireless LAN access point (AP) is capable of measuring how many mobile nodes MN belong to the access point and how much traffic is used. Consequently, the number of remaining bands can be calculated by deducting currently-used bands from bands that are usable substantially. If the number of remaining bands is included in, for example, a broadcast frame and sent to the mobile node MN, it becomes possible for the mobile node MN to grasp how many free bands are present currently.

As shown in FIG. 10, it is also possible that a management node SN is provided to notify the mobile node MN of not only an amount of traffic on one wireless access point AP but also states of the other wireless access points AP. In other words, each AP informs the management node SN of its own free band, and the AP distributes necessary information to the other wireless access points AP. The wireless access points AP can inform the mobile node MN of not only information of the wireless access points AP themselves but also information obtained from the management node.

As described above, according to the embodiment, the mobile node MN can grasp free bands in networks and wireless sections and can use the information for selecting an optimal network. In addition, selection of an optimal handover method also becomes possible using the obtained information.

1. A communication apparatus capable of communicating with a correspondent node via plural networks, comprising:
a quality acquiring unit that acquires communication quality information for each of the plural networks;
a storing unit that stores conditions required by an application using the networks;
a selecting unit that compares the required conditions in the storing unit and the communication quality information of the respective networks and selects a network satisfying the required conditions; and
a communication control unit that performs communication via the network selected by the selecting unit.

2. A communication apparatus according to claim 1, wherein when the communication control unit sends a packet in accordance with the application, the communication control unit sends the packet through the network selected by the selecting unit.

3. A communication apparatus according to claim 1, wherein the communication control unit notifies the correspondent node of information on the network selected by the selecting unit and receives a packet from the correspondent node via the selected network.

4. A communication apparatus according to claim 1, wherein when communication is performed with the correspondent node via a relay node for relaying a packet from the correspondent node,
the quality acquiring unit acquires communication quality information from the relay node.

5. A communication apparatus according to claim 1, wherein when communication is performed with the correspondent node via a relay node,
the quality acquiring unit collects information on communication quality of the network, and
the communication control unit notifies the relay node of information on the network selected by the selecting unit and receives a packet from the relay node via the selected network.

6. A communication apparatus according to claim 1, wherein when a network satisfying the required conditions is not present, the selecting unit selects a network in accordance with conditions for selection that are applied in a case in which a network satisfying the required conditions is not present.

7. A communication apparatus according to claim 1, wherein when plural applications using the network are present simultaneously, the selecting unit selects networks used by the respective applications in accordance with conditions for selection among the applications.

8. A communication apparatus according to claim 1, wherein when the network is switched,
the selecting unit selects and executes a method of switching the network according to communication quality information of the network before and after the switching.

9. A communication apparatus according to claim 1, wherein when the network is switched, and a transfer differential delay before and after the switching is larger than a threshold value,
at least one of the communication control unit and the relay node buffers a packet in handover processing for the switching.

10. A communication apparatus according to claim 1, wherein the quality acquiring unit inquires of a specific node, which collects information on a state in a network, about a state of a pertinent network and acquires communication quality information.

11. A communication apparatus according to claim 1, wherein an access point of the network notifies communication quality information of the access point itself, and the quality acquiring unit acquires the communication quality information.

12. A communication apparatus according to claim 1, wherein an access point of the network notifies other access points of communication quality information of itself, and an access point having received the communication quality information notifies the notified communication quality information of other access points in addition to a quality state of the access point itself.

13. A communication apparatus according to claim 1, wherein the quality acquiring unit acquires communication quality information only in a case in which an application requiring acquisition of communication quality is used and acquires no communication quality information in a case in which an application not requiring acquisition of communication quality is used.

14. A communication system, comprising:
a relay node that relays a packet from a correspondent node to a communication apparatus moving among plural networks; and
a communication apparatus that performs communication with the correspondent node via the plural networks, wherein:
the relay node includes:
a quality detecting unit that detects communication quality information of the plural networks;
a quality notifying unit that notifies the communication apparatus of the communication quality information;
a selection information receiving unit that receives information on a selected network from the communication apparatus; and
a transferring unit that transfers a packet addressed to a home address of the communication apparatus from the correspondent node to the communication apparatus via the selected network; and
the communication apparatus includes:
a quality acquiring unit that acquires communication quality information from the relay node;
a storing unit that stores conditions required by an application using the network;
a selecting unit that compares the required conditions in the storing unit and communication quality information of the respective networks and selects a network satisfying the required conditions; and
a communication control unit that notifies the relay node of information on the network selected by the selecting unit and receives a packet sent from the relay node via the selected network.

15. A communication method executed in a communication apparatus that is capable of communicating with a correspondent node via plural networks, comprising step of:
acquiring communication quality information for each of the plural networks;
referencing a storing unit that stores conditions required by an application using the network, comparing the required conditions and the communication quality information of the respective networks, and selecting a network satisfying the required conditions; and
performing communication via the network selected by the selecting unit.

16. A communication method according to claim 15, wherein in the step of performing communication, in a case in which a packet is sent in accordance with the application, the packet is sent through the selected network.

17. A communication method according to claim 15, wherein in the step of performing communication, information on the selected network is notified to a correspondent node and a packet is received from the correspondent node via the selected network.

18. A communication method according to claim 15, wherein when communication is performed with the correspondent node via a relay node,
communication quality information is acquired from the relay node.

19. A communication method according to claim 15, wherein when communication is performed with the correspondent node via a relay node,
in the step of acquiring communication quality information, information on communication quality of the network is collected, and
information on the selected network is notified to the relay node on the basis of the communication quality information, and a packet is received from the relay node via the selected network.

20. A communication method according to claim 15, wherein in the step of selecting a network, in a case in which a network satisfying the required conditions is not present, a network is selected in accordance with conditions for selection that are applied in a case in which a network satisfying the required conditions is not present.

21. A communication method according to claim 15, wherein in the step of selecting a network, in a case in which plural applications using the network are present simultaneously, networks used by the respective applications are selected in accordance with conditions for selection among the applications.

22. A communication method according to claim 15, wherein when the network is switched,
in the step of selecting a network, a method of switching the network is selected and executed according to communication quality information of the network before and after the switching.

23. A communication method according to claim 15, wherein when the network is switched, and a transfer differential delay before and after the switching is larger than a threshold value, packet in handover processing for the switching is buffered.

24. A communication method according to claim 15, wherein in the step of acquiring communication quality information, a specific node, which collects information on a state in a network, is inquired about a state of a pertinent network, and communication quality information is acquired from the node.

25. A communication method according to claim 15, wherein when an access point of the network notifies communication quality information of the access point itself, in the step of acquiring communication quality information, the communication quality information from the access point is acquired.

26. A communication method according to claim 25, wherein an access point of the network notifies other access points of communication quality information of itself, and an access point having received the communication quality information notifies the notified communication quality information of other access points in addition to a quality state of the access point itself.

27. A communication method according to claim 15, wherein in the step of acquiring communication quality information, communication quality information is acquired only in a case in which an application requiring acquisition of communication quality is used, and communication quality information is not acquired in a case in which an application not requiring acquisition of communication quality is used.

28. A communication method executed in a communication system including:
a relay node that relays a packet from a correspondent node to a communication apparatus moving among plural networks; and a communication apparatus that performs communication with the correspondent node via the plural networks, comprising:
causing the relay node to perform:
detecting communication quality information of the plural networks;
notifying the communication apparatus of the communication quality information;
receiving information on a selected network from the communication apparatus; and
transferring a packet addressed to the communication apparatus from the correspondent node to the communication apparatus via the selected network; and
causing the communication apparatus to perform:
acquiring communication quality information from the relay node;
referencing a storing unit that stores conditions required by an application using the network, comparing the required conditions and communication quality information of the respective networks, and selecting a network satisfying the required conditions; and
a communication control step of notifying information on the selected network to the relay node and receiving a packet sent from the relay node via the selected network.

29. A storage medium which stores a communication program that is run on a communication apparatus capable of performing communication with a correspondent node via plural networks,
the storage medium causing the communication apparatus to execute step of:
acquiring communication quality information for each of the plural networks;
referencing a storing unit that stores conditions required by an application using the network, comparing the required conditions and the communication quality information of the respective networks, and selecting a network satisfying the required conditions; and
performing communication via the network selected by the selecting unit.

30. A storage medium according to claim 29, wherein, in the step of performing communication, in a case in which a packet is sent in accordance with the application, the packet is sent through the selected network.

31. A storage medium according to claim 29, wherein, in the step of performing communication, information on the selected network is notified to a correspondent node and a packet is received from the correspondent node via the selected network.

32. A storage medium according to claim 29, wherein, in a case in which communication is performed with the correspondent node via a relay node, communication quality information is acquired from the relay node.

33. A storage medium according to claim 29, wherein, in a case in which communication is performed with the correspondent node via a relay node, in the step of acquiring communication quality information, information on communication quality of the network is collected, and information on the selected network is notified to the relay node on the basis of the communication quality information, and a packet is received from the relay node via the selected network.

34. A storage medium according to claim 29, wherein, in the step of selecting a network, in a case in which a network satisfying the required conditions is not present, a network is selected in accordance with conditions for selection that are applied in a case in which a network satisfying the required conditions is not present.

35. A storage medium according to claim 29, wherein, in the step of selecting a network, in a case in which plural applications using the network are present simultaneously, networks used by the respective applications are selected in accordance with conditions for selection among the applications.

36. A storage medium according to claim 29, wherein, in a case in which the network is switched,
in the step of selecting a network, a method of switching the network is selected according to communication quality information of the network before and after the switching and executed.

37. A storage medium according to claim 29, wherein, in a case in which the network is switched, and a transfer differential delay before and after the switching is larger than a threshold value, packet in handover processing for the switching is buffered.

38. A storage medium according to claim 29, wherein, in the step of acquiring communication quality information, a specific node, which collects information on a state in a network, is inquired about a state of a pertinent network, and communication quality information is acquired from the node.

39. A storage medium according to claim 29, wherein, in a case in which an access point of the network notifies communication quality information of the access point itself, in the step of acquiring communication quality information, the communication quality information from the access point is acquired.

40. A storage medium according to claim 39, wherein, an access point of the network notifies other access points of communication quality information of itself, and an access point having received the communication quality information notifies the notified communication quality information of other access points in addition to a quality state of the access point itself.

41. A storage medium according to claim 29, wherein, in the step of acquiring communication quality information, communication quality information is acquired only in a case in which an application requiring acquisition of communication quality is used, and communication quality information is not acquired in a case in which an application not requiring
